(19) United States
(12) Patent Application Publication
(10) Pub. No.: US 2007/0251241 A1
(43) Pub. Date: Nov. 1, 2007

(54) Hydrogen-fired hollow generator

(76) Inventor: William Sheridan Fielder, Ojai, CA (US)

Correspondence Address: WILLIAM S. FIELDER, P.O. BOX 1221, OJAI, CA, 93024-1221, US

(21) Appl. No.: 11/820,971

(22) Filed: Jun. 21, 2007

Related U.S. Application Data
(63) Continuation-in-part of application No. 10/916,346, filed on Aug. 10, 2004, now abandoned.
(60) Provisional application No. 60/494,186, filed on Aug. 11, 2003.

(51) Int. Cl. F02C 3/00

(52) U.S. Cl. 60/804; 204/554

(57) ABSTRACT

A hydrogen-fired all-in-one electric generator/turbine that requires less rotational energy, substantially fewer parts, and less space in the power plant than traditional designs. The turbine is embedded within the rotor, each sharing a common, shaftless axis of rotation, and as a result, reduces the overall weight and size of the turbine/generator. The electric generator is energized by an energy capture system that captures the heat and thrust produced from a hydrogen and oxygen reaction. This is accomplished by means of heat exchangers and turbines, as well as the aforementioned generator/turbine. The system is intended to replace steam generators that rely on fossil fuels and uranium and used in electric power plants. These power plants will be able to install more generators in the same amount of space. More generators operating at higher rates of rotation will significantly increase the electric power generated. Water that results from the hydrogen and oxygen reaction is captured by the water management system, and may be used to supplement or completely supply a community's water requirements.

### CROSS-REFERENCE TO RELATED APPLICATIONS

This application is a continuation-in-part of application Ser. No. 10/916,346, filed Aug. 10, 2004 by the present inventor, which is incorporated by reference and benefits from provisional patent application No. 60/494,186, filed Aug. 11, 2003.

This application uses the electric generator and related technologies disclosed in my patent application Ser. No. 11/803,062, filed May 11, 2007 by the present inventor, which is incorporated by reference.

This application uses the turbine and related technologies disclosed in my patent application Ser. No. 10/885,876, filed Jul. 6, 2004 by the present inventor, which is incorporated by reference.

### FEDERALLY SPONSORED RESEARCH

None.

### SEQUENCE LISTING

None.

### BACKGROUND OF INVENTION—FIELD OF INVENTION

This invention generally relates to the field of hydrogen combustion systems; specifically it relates to electricity and steam generation, water recovery, and energy capture systems.

### BACKGROUND OF INVENTION—PRIOR ART

Currently the steam generators used in electric power plants rely on hydrocarbon based fuels or uranium.

The negative externalities associated with hydrocarbon based fuels include but are not limited to: “greenhouse gases,” mercury poisoning, oil spills, and limited availability that threatens our national security and economic stability.

The negative externalities associated with uranium based fuels include but are not limited to: the long-term health risks associated with accidental exposure, toxic by-products with half-lives ranging into the millions of years, national security and environmental issues associated with transporting nuclear waste, and long-range waste storage solutions.

Fuel cells have been seen by many as the means to replace these toxic energy sources. However fuel cells have their own limitations as compared to this invention. Limitations associated with Proton Exchange Membrane fuel cells, or PEM, the most developed of the available fuel cells, include but are not limited to: fuel cell cores that are expensive to build and maintain, and complex heat and water management. Phosphoric acid fuel cells used in medium to large-scale power generation suffer from: low efficiency, limited service life, and an expensive catalyst. Solid oxide fuel cells, also suitable for medium to large-scale power generation are limited by: high operating temperatures, exotic metals, high manufacturing costs, oxidation issues, and low specific power.

### SUMMARY

An embodiment of the invention includes a combustion chamber for a hydrogen and oxygen reaction, for the purpose of capturing the resultant thrust and heat, as well as the water produced. Thrust is captured by an all-in-one turbine/generator and transformed into electrical energy. Heat is captured by one, or possibly multiple heat exchangers and transformed into rotational energy by a turbine that connects to an electric generator. The hydrogen utilized is intended to replace the fuels that are currently used to fire steam generators in electric power plants; the water captured is intended to supplement or entirely provide for a community's water supply.

### DRAWINGS—FIGURES

FIG. 1 illustrates a hydrogen-fired all-in-one electric generator/turbine comprising: a combustion chamber including both interior and exterior heat exchangers, together with an attached turbine/generator, and a water management system means.

FIG. 1a is a front view of FIG. 1 depicting a directional cone with helical supports, turbine blades, distal edges of the blades, rotor supports, and rotor.

FIG. 2 is an alternative embodiment of FIG. 1: a combustion chamber including only an external heat exchanger, together with an attached turbine/generator, and a water management system means.

FIG. 2a is identical to FIG. 1a and does not reflect the missing heat exchanger.

FIG. 3 is an alternative embodiment of FIG. 1: a combustion chamber including both interior and exterior heat exchangers, together with an attached turbine/generator, and a water management system means. Absent rotor supports, the outer diameter of the turbine is just smaller than the inner diameter of the generator's rotor.

FIG. 3a is identical to FIG. 1a, absent the rotor supports.

FIGS. 4 and 4a are the same as FIGS. 3 and 3a, except with the exclusion of an interior heat exchanger.

FIGS. 5 and 5a are an alternative embodiment of FIGS. 1 and 1a, without a directional cone and helical supports.

FIGS. 6 and 6a are an alternative embodiment of FIGS. 1 and 1a, without a directional cone, helical supports, and the internal heat exchanger.

FIGS. 7 and 7a are an alternative embodiment of FIGS. 1 and 1a, without rotor supports, as well as a directional cone, and helical supports.

FIGS. 8 and 8a are an alternative embodiment of FIGS. 1 and 1a, without rotor supports, a directional cone, helical supports, and internal heat exchanger.

FIG. 9 is an alternative embodiment of FIG. 1, but with the multiple hydrogen and oxygen injectors.

FIG. 10. is an alternative embodiment of FIG. 1, but utilizes slip rings, brushes and an external power supply instead of the preferred exciter.

FIG. 11 illustrates an offshore hydrogen production plant and an onshore hydrogen-fired electric generator.

### DRAWINGS—REFERENCE NUMERALS

1. HYDROGEN-FIRED HOLLOW GENERATOR

2. Combination chamber

3. Hydrogen injector

4. Oxygen injector

5. Exterior heat exchanger

6. Water injector for the exterior heat exchanger

7. Steam exhaust conduit to turbine for the exterior heat exchanger

8. Interior heat exchanger

9. Water injector for the interior heat exchanger

10. Steam exhaust conduit to turbine for the interior heat exchanger

11. Nozzle

12. Insulated intake pipe

13. Turbine shroud

14. Directional cone

15. Helical supports

16. Turbine blades

17. Turbine blade's distal edge

18. Insulated ring spacer in between the blades' base and the inner surface of the turbine's cylinder

19. Turbine cylinder

20. Turbine bearing

21. Rotor support (structural support)

22. Inner surface of the insulated intake pipe

23. Rotor

24. Rotor magnets

25. Stator, wire coils

26. Exciter, rotor wire inductor coils

27. Exciter, stationary magnets

28. Exciter, diode bridge (aka bridge rectifier)

29. Insulated exhaust pipe

30. Insulated tapered exhaust pipe

31. Turbine shroud

32. Water management system means element

33. Support structure

34. Slip ring

35. Brush

36. Stationary contact

37. Directional funnel

38. Turbine blades

39. Turbine

40. Rotational energy connecting element

41. Electric generator rotor

42. Electric generator stator

43. Distillation means

44. Electrolyzer

45. Support structure

46. Hydrogen pipeline

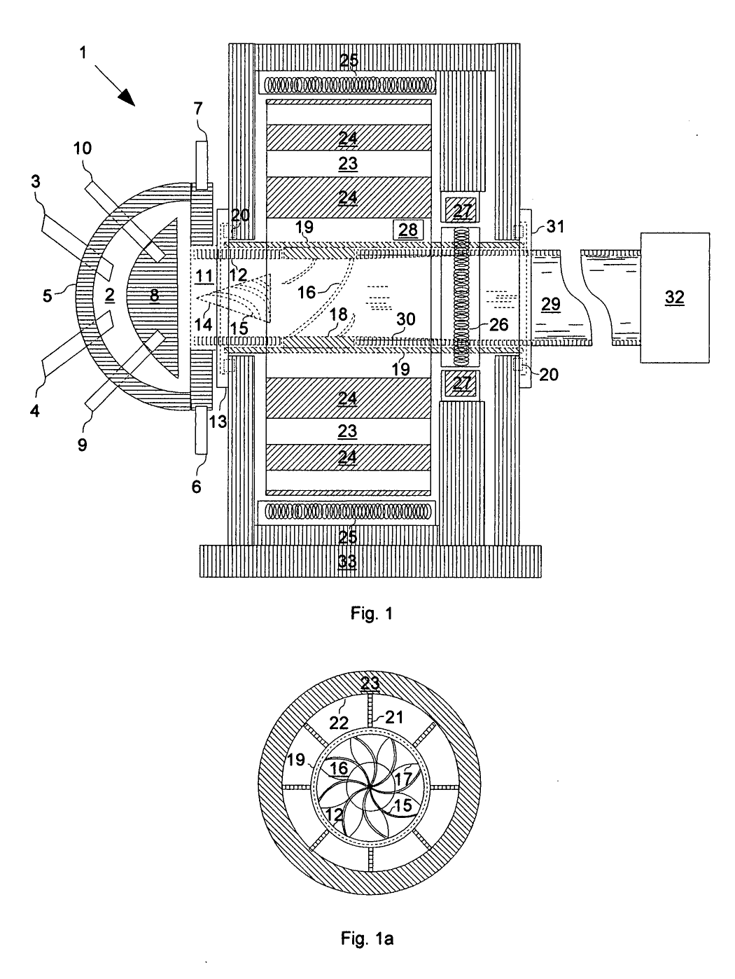

### DETAILED DESCRIPTION—FIGS. 1 & 1a

FIG. 1 shows an embodiment of a HYDROGEN-FIRED HOLLOW GENERATOR 1 comprised of a combustion chamber 2, with attached heat exchangers 5 and 8, that connect to a turbine shroud 13 that is itself attached to a support structure 33. The two injectors, one each for hydrogen 3 and oxygen 4, are optimally located within the combustion chamber 2 to produce the maximum possible amount of energy.

Immediately adjacent to the hydrogen 3 and oxygen 4 injectors, and located within the combustion chamber 2 itself, is a heat exchanger 8. Attached to the heat exchanger 8, is a water injector 9 and a conduit for the steam generated 10. The steam is subsequently channeled to a steam turbine, not shown, distilled, also not shown, and returned to the water injector 9. Said steam is generated from water or another more suitable substance.

The exterior heat exchanger's elements 5 are arranged for optimal heat recovery. The exterior heat exchanger 5 also is comprised of a water injector 6, a conduit for the steam generated 7, and a means to recycle the steam generated, not shown.

A nozzle 11 connects the combustion chamber 2 to the turbine shroud 13 and the insulated intake pipe 12, that channels the thrust from the combustion chamber 2 to the most efficient portion of the turbine blades 16 via the directional cone 14 and helical supports 15. Turbine blades 16 attach to an optional insulated ring spacer 18 that is fastened to the inner surface of turbine cylinder 19.

The rotor 23 includes a plurality of magnets 24, together with exciter components that include induction coils 26, and a diode bridge 28 that connects electrically to rotor magnets 24. Stationary exciter magnets 27 are positioned around the periphery of the exciter induction coils 26. The turbine cylinder 19 is attached to the support structure 33 by bearings 20 that permit the rotor to rotate freely in close proximity to the stators 25 and stationary exciter magnets 27. The rotor 23 and turbine cylinder 19 are connected by supports 21, as shown in FIG. 1a.

The insulated, tapered exhaust pipe 30 connects to the turbine shroud 31, and to the insulated exhaust pipe 29 that connects to the means of water management 32.

The support structure 33 supports the rotor 23 by means of bearings 20. It also positions the electric generator's stators 25 and the exciter's stationary magnets 27 in close proximity to the generator's rotor 23 and exciter's rotor induction coils 26, respectively.

Operation—FIGS. 1 & 1a:

Similar to the operation of a rocket engine, the HYDROGEN-FIRED HOLLOW GENERATOR 1 combines hydrogen from the hydrogen injector 3 and oxygen from the oxygen injector 4 in the combustion chamber 2 to produce heat, thrust, and water vapor.

Water or other suitable substance is transformed into steam or a gas by the heat from the interior heat exchanger 8 and the exterior heat exchanger 5. The steam or gas is transferred via conduits 7 and 10 to at least one turbine, not shown. Presumably, the attached turbines will provide the rotational energy necessary for electric generators, also not shown. The steam or gas is then distilled and recycled, not shown, into the heat exchangers' water injectors 6 and 9.

Thrust and water vapor, from the reaction, enter the turbine/generator via the nozzle 11 and through the insulated intake pipe 12 that connects to the directional cone 14. Thrust and water vapor are channeled, by helical supports 15, in a direction perpendicular to the most efficient surface area of the turbine blades 16. The resulting force on the blades 16 rotates the turbine cylinder 19 and attached rotor 23.

Electromagnets 24, on the rotor 23, are energized by the field current generated by the rotating induction coils 26 that pass in close proximity to stationary magnets 27, that alternate in polarity. The generated field current is converted into direct current by the diode bridge 28. Electric conductors, not shown, transmit the electricity, induced by the exciter coils 26, to the diode bridge 28 and then to the electromagnets 24.

Stators 25 are energized by the alternating magnetic fields produced by the rotating electromagnets 24 on the rotor 23, with the resulting electricity transferred to transformers for distribution.

Water vapor exits the turbine via the downward sloping exhaust pipe 30 into the water management means 32. Thus, the present invention provides the same function as other designs, but does so more efficiently by using a fewer number of lighter weight parts. The resulting electricity and water may supplement or entirely provide for a community's water and power needs.

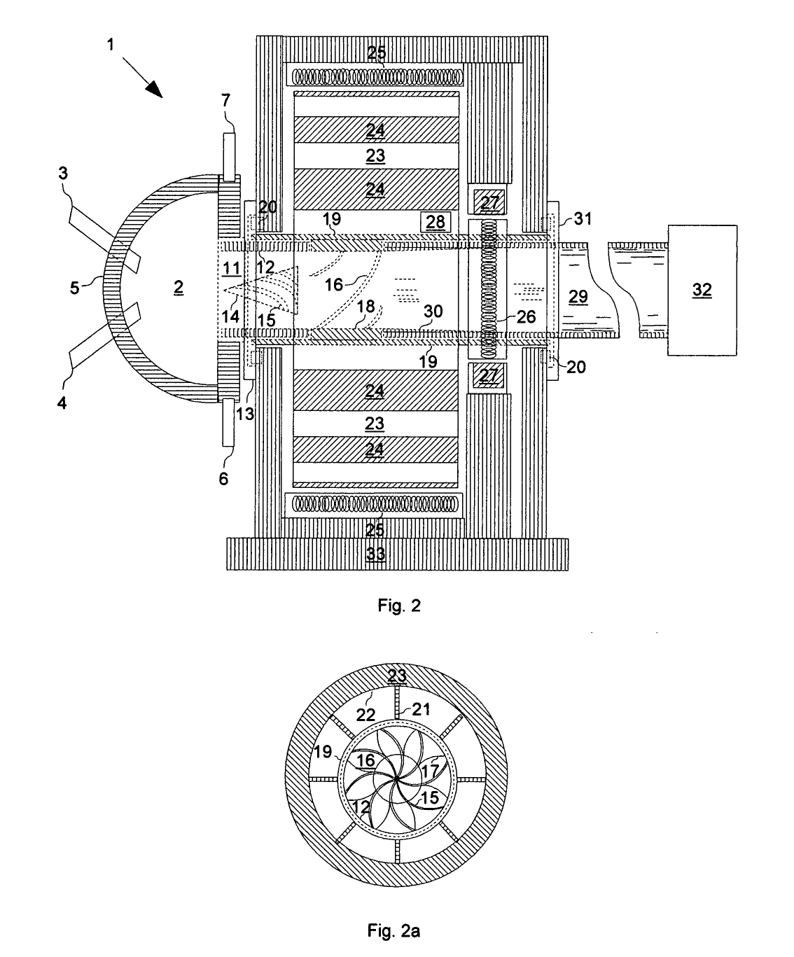

Alternative Embodiment—FIGS. 2 & 2a:

This embodiment is identical to the embodiment of FIGS. 1 and 1a, but without the internal heat exchanger. Operation is the same as previously described.

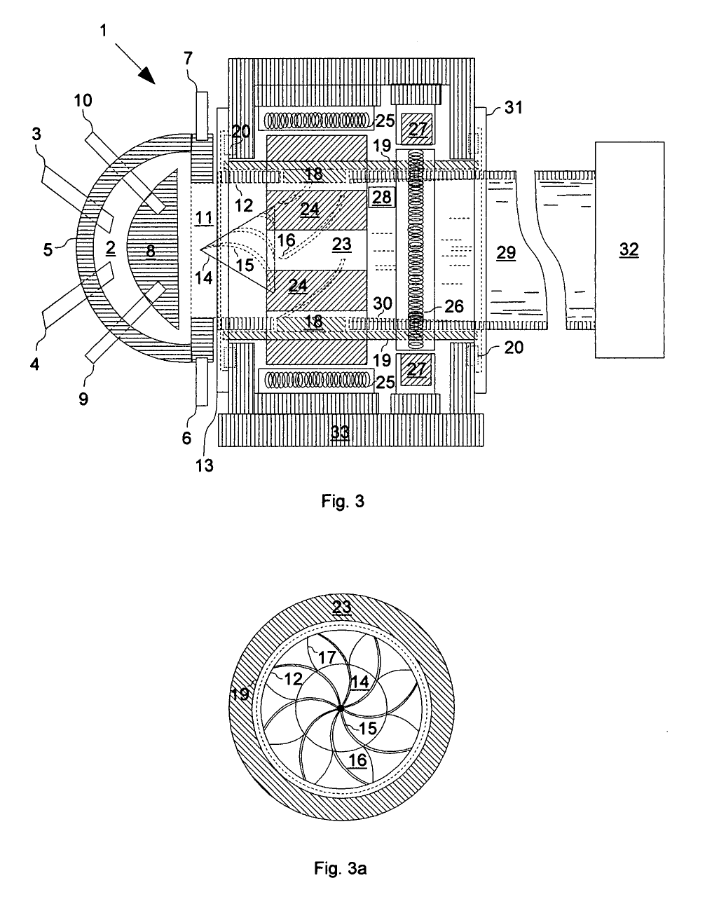

Alternative Embodiment—FIGS. 3 & 3a:

This embodiment is identical to the embodiment of FIGS. 1 and 1a, absent the rotor supports. This results in a larger directional cone and turbine cylinder. Operation is the same as previously described.

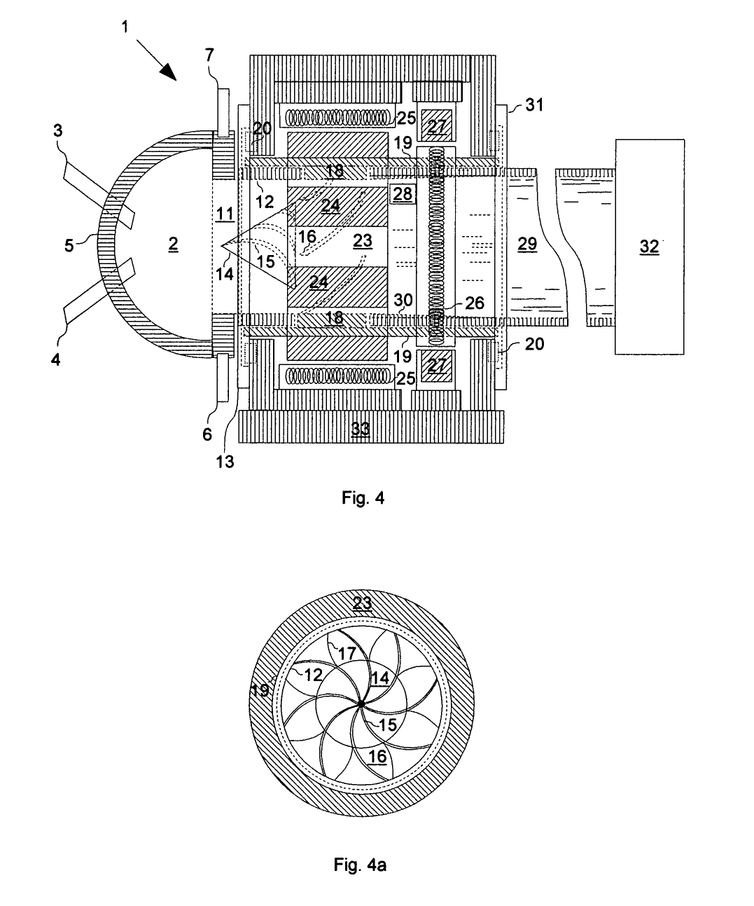

Alternative Embodiment—FIGS. 4 & 4a

This embodiment is identical to the embodiment of FIGS. 1 and 1a, minus the rotor supports and without the internal heat exchanger. Operation is the same as previously described.

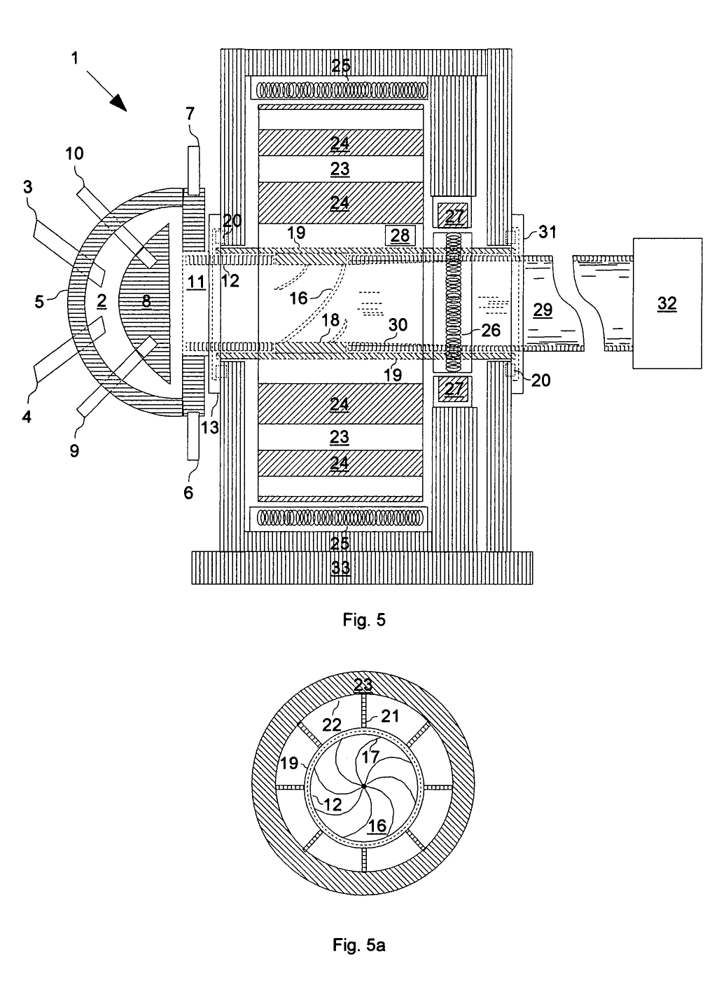

Alternative Embodiment—FIGS. 5 & 5a

This embodiment is identical to the embodiment of FIGS. 1 and 1a, but without the directional cone. Operation is the same as previously described.

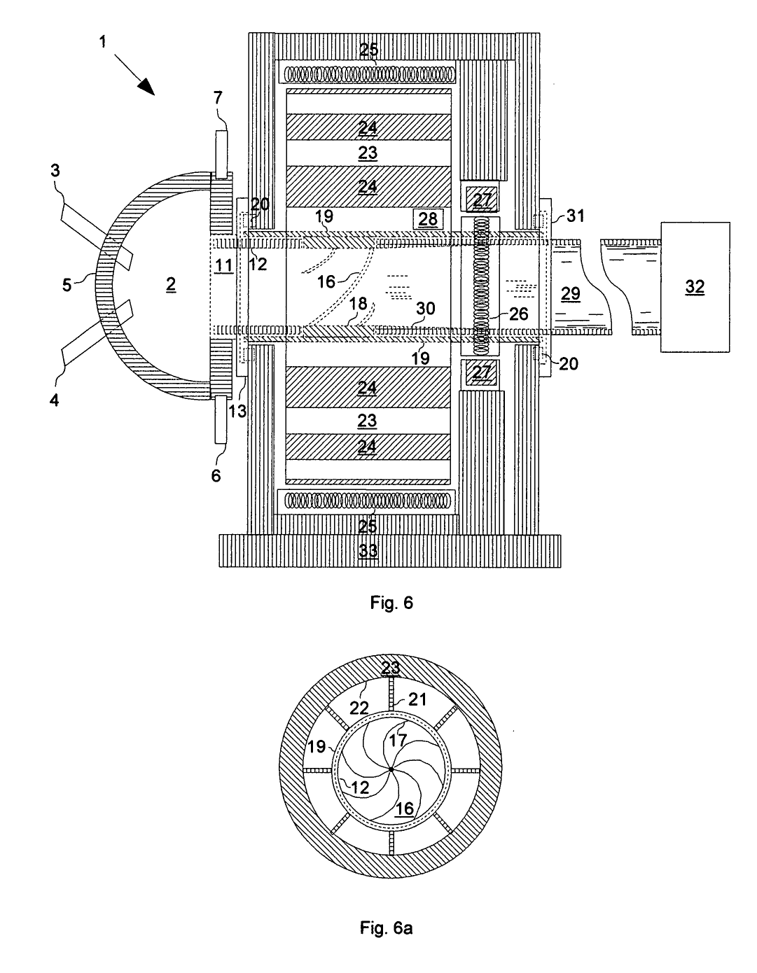

Alternative Embodiment—FIGS. 6 & 6a

This embodiment is identical to the embodiment of FIGS. 1 and 1a, minus the internal heat exchanger and the directional cone. Operation is the same as previously described.

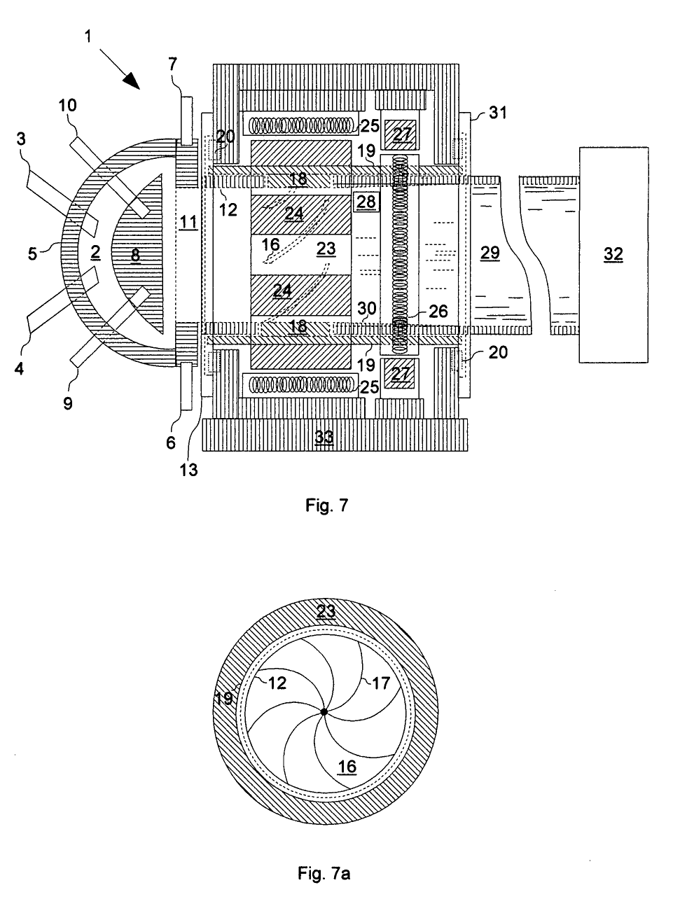

Alternative Embodiment—FIGS. 7 & 7a

This embodiment is identical to the embodiment of FIGS. 1 and 1a, absent the rotor supports and the directional cone. Operation is the same as previously described.

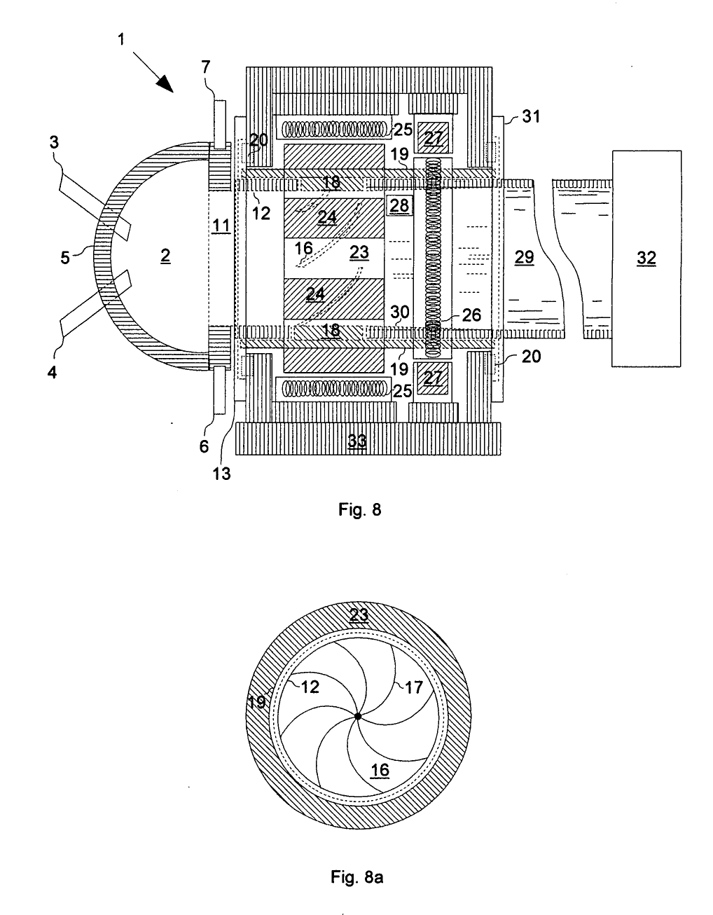

Alternative Embodiment—FIGS. 8 & 8a

This embodiment is identical to the embodiment of FIGS. 1 and 1a, but absent the rotor supports, the internal heat exchanger, and the directional cone. Operation is the same as previously described.

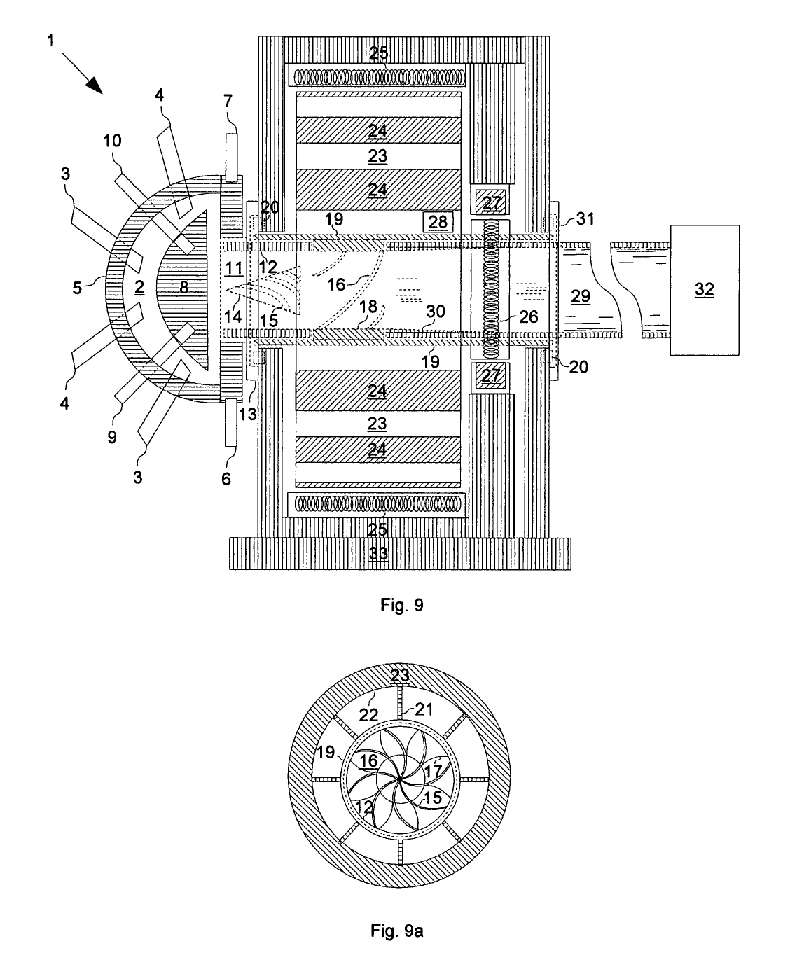

Alternative Embodiment—FIGS. 9 & 9a

This embodiment is identical to the embodiment of FIGS. 1 and 1a, but with multiple oxygen and hydrogen injectors. Operation is the same as previously described.

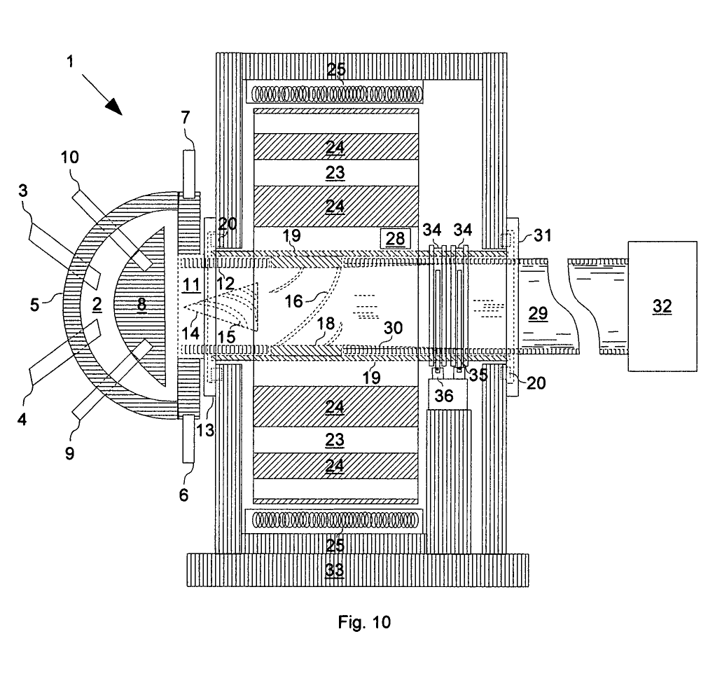

Alternative Embodiment—FIG. 10

This embodiment is identical to the embodiment of FIGS. 1 and 1a, but substitutes slip rings, brushes, and stationary contacts for the exciter. Operation is the same as previously described, with the exception that the field current is supplied, rather than generated locally.

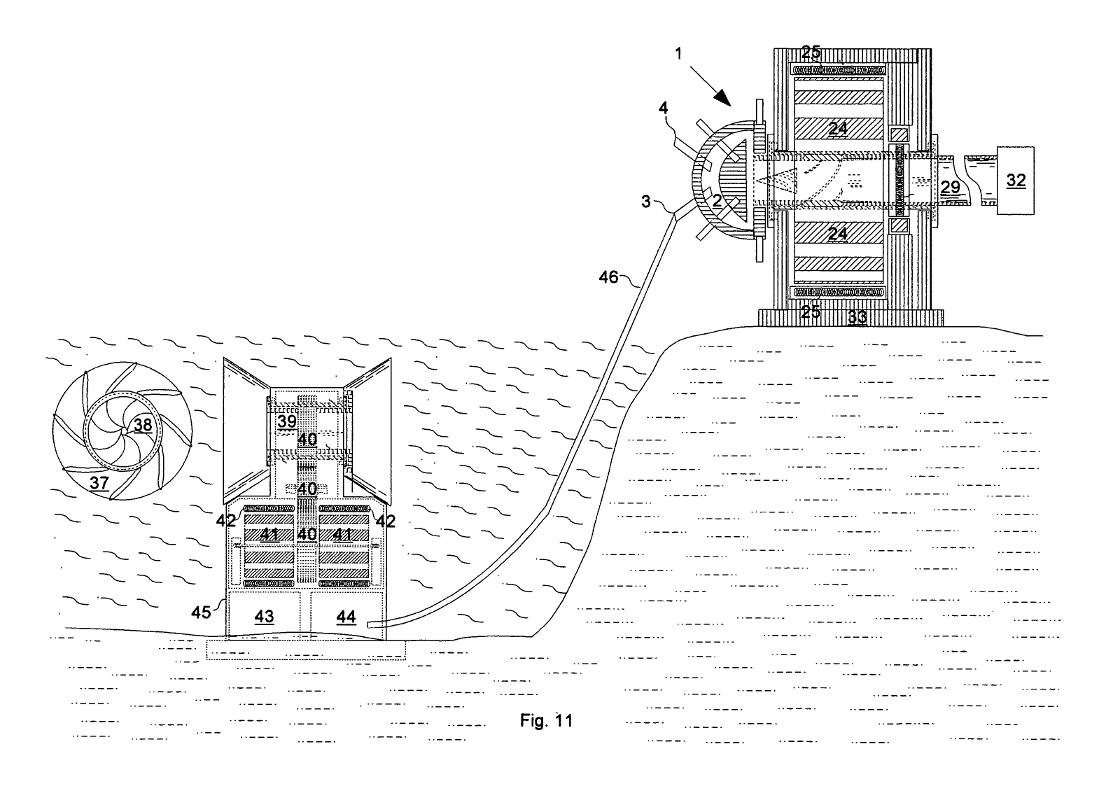

Alternative Embodiment—FIG. 11

This embodiment illustrates a HYDROGEN-FIRED HOLLOW GENERATOR 1 with an attached hydrogen production facility 45. An optional directional funnel 37 is attached to a support structure 45 that houses an optional turbine 39, optional rotational energy connecting elements 40, and an optional electric generator comprised of rotors 41 and stators 42. Also contained within the support structure 45 are, a means of first distilling 43 and then electrolyzing 44 ocean water. The resulting hydrogen is exported, via a pipeline 46, to a hydrogen-fired electric generator 1.

The kinetic energy from passing ocean currents and tides is captured by and transformed into rotational energy by an optional turbine 39. The rotational energy is transferred to the rotors 41 via the optional rotational energy connecting elements 40. The alternating magnetic fields produced by the optional spinning rotors 41 induces electric current in the optional stators 42.

Electricity, generated locally or imported, energizes heating coils, not shown, to distill ocean water 43. The same electricity is also incorporated to electrolyze 44 the resulting distilled water.

The oxygen produced from electrolysis 44 may be utilized to provide life support for the underwater factory 45.

The hydrogen produced is exported, via a pipeline 46, to the combustion chamber 2 of the HYDROGEN-FIRED HOLLOW GENERATOR 1 that combines the hydrogen with oxygen to produce heat, thrust, and water vapor that are all captured by the HYDROGEN-FIRED HOLLOW GENERATOR 1. The resulting water and electric power are exported for use elsewhere, not shown.

Advantages:

From the description above, a number of advantages of some embodiments of my hydrogen-fired electric generator become evident:
a. An environmentally friendly supply of fuel is provided to fire the electric generators commonly found in electric power plants.
b. They are more efficient than separate steam turbines and electric generators that are usually connected by a shaft.
c. They are affordable to build and maintain.
d. The embodiments also supplement or entirely provide for a community's water supply by furnishing a means for water collection,
e. Redundant hydrogen pipelines will provide fault tolerance.

### CONCLUSION, RAMIFICATIONS, AND SCOPE

Thus, the reader will see that this invention provides for an environmentally friendly means of producing steam and thrust, to be later transformed into electricity and water.

The invention will be of interest to utility companies who can reduce costs, eliminate hazardous emissions, and improve public relations, by incorporating nontoxic solutions. Consumers will enjoy a safer, cleaner, more affordable, and readily available source of water and power.

A plurality of hydrogen sources will provide fault tolerance in the event of a severed pipeline or other catastrophic event, thus avoiding any disruption of water and power delivery.

The shape of the combustion chamber may be transformed into more than just the semicircular configuration shown here. It could, for example, take the form of an oval.

The heat exchangers, as previously described, may also preheat water or other substances. Multiple layers, perhaps coiled, of heat exchanger elements may be necessary to capture all of the generated heat.

All materials used in the fabrication of parts that may come into contact with the resultant water from the hydrogen and oxygen reaction must be nontoxic. The turbine cylinder and blades may be fabricated from composite carbon fibers and or titanium. Stainless steel is a feasible material; however, it is heavier than the aforementioned composite carbon fibers and or titanium.

While my above description contains many specificities, these should not be construed as limitations on the scope of the invention, but as merely providing illustration of some of the presently preferred embodiments.

Accordingly, the scope of the invention should be determined not by the embodiments illustrated, but by the appended claims and their legal equivalents.

I claim:

1. A hydrogen-fired electric generator comprising:
a combustion chamber, wherein said combustion chamber is for a hydrogen and oxygen reaction;
at least one turbine/rotor comprising: a HOLLOW TURBINE comprising: at least one array of blades attached within a cylinder that is absent any center shaft and free to rotate, and at least one array of magnets mounted on the outer surface of the HOLLOW TURBINE's cylinder,
at least one stator comprising: at least one stationary induction coil of an electric conductor,
a supporting structure,
whereby efficiently producing electricity in an environmentally friendly manner.

2. The hydrogen-fired electric generator as claimed in claim 1, further comprising at least one heat exchanger to capture the resultant heat from said hydrogen and oxygen reaction in said combustion chamber;

3. The hydrogen-fired electric generator as claimed in claim 1, further comprising a means for capturing the water resulting from said hydrogen and oxygen reaction; whereby producing pure water in an environmentally friendly manner.

4. The hydrogen-fired electric generator as claimed in claim 3, wherein said water capturing means is a means of distillation.

5. The hydrogen-fired electric generator as claimed in claim 1, further comprising at least one means to inject the hydrogen and oxygen into said combustion chamber.

6. The hydrogen-fired electric generator as claimed in claim 5, wherein said hydrogen and oxygen injection means is a plurality of hydrogen and oxygen injectors.

7. The hydrogen-fired electric generator as claimed in claim 1, further comprising a means for allowing said HOLLOW TURBINE to rotate freely within close proximity to said at least one stator, wherein said means are bearings.

8. The hydrogen-fired electric generator, as claimed in claim 1, further comprising:
an intake pipe whose outer diameter is less than the inner diameter of said cylinder, wherein said intake pipe is mounted inside said cylinder, preventing incoming steam from making contact with said cylinder until said steam comes into direct contact with the HOLLOW TURBINE's blades, whereby the heat from the generated steam, from said hydrogen and oxygen reaction, is insulated away from the generator's rotor.

9. The hydrogen-fired electric generator as claimed in claim 8, further comprising: a cone, attached to the inside surface of said intake pipe by at least one support directly before the HOLLOW TURBINE's blades, wherein said support directs incoming flows to the most efficient part of the HOLLOW TURBINE's blades, whereby it is now possible to increase the size of the turbine/rotor, thus providing greater leverage that results in more electricity being generated.

10. The hydrogen-fired electric generator as claimed in claim 9, wherein said at least one support is helical in shape, such that incoming flows are channeled in a perpendicular direction to the turbine's blades, whereby efficiency is significantly enhanced.

11. The hydrogen-fired electric generator, as claimed in claim 1, further comprising:
an exhaust pipe whose outer diameter is less than the inner diameter of said cylinder, wherein said exhaust pipe is mounted inside said cylinder, behind the turbine blades, preventing exiting flow from making contact with said cylinder, whereby the heat from the generated steam, from said hydrogen and oxygen reaction, is insulated away from the generator's rotor.

12. The hydrogen-fired electric generator, as claimed in claim 1, further comprising:
a ring spacer to fit in between the inner surface of said cylinder and the base of the turbine blades, wherein the base of the blades is even in elevation to the inner surfaces of said intake and exhaust pipes.

13. The hydrogen-fired electric generator as claimed in claim 1, wherein said magnets are electromagnets.

14. The hydrogen-fired electric generator as claimed in claim 13, further comprising an exciter.

15. The hydrogen-fired electric generator as claimed in claim 14 wherein said exciter comprises:
at least one coil of an electric conductor, i.e., an inductor, mounted to the outer surface of said cylinder of said HOLLOW TURBINE as claimed in claim 1, and electrically connected to the electromagnets as claimed in claim 13,
at least one pair of stationary magnets positioned around said at least one coil of an electric conductor, whereby providing field current to said electromagnets.

16. The hydrogen-fired electric generator as claimed in claim 14 further comprising at least one electrically connected diode bridge, i.e., bridge rectifier, between said at least one coil of an electric conductor and said electromagnets, whereby providing direct current to said electromagnets.

17. The hydrogen-fired electric generator as claimed in claim 14, further comprising two slide rings electrically connected to said electromagnets, two brushes and two stationary contacts, connected to an electric power source, whereby providing field current to said electromagnets.

18. The hydrogen-fired electric generator as claimed in claim 1, wherein said magnets are permanent magnets.

19. A method of generating electricity comprising:
injecting hydrogen and oxygen into a combustion chamber, and
channeling the thrust from the hydrogen and oxygen reaction to turbine blades mounted within a cylinder that is free to rotate and has no center shaft,
rotating magnets attached on the outer surface of said cylinder produce alternating magnetic fields, and
inducing current in at least one stator mounted in close proximity to said rotating magnets,
whereby producing electricity efficiently in an environmentally friendly manner.

20. The method claim of claim 19, further includes, providing heat exchangers to capture the heat resulting from the hydrogen and oxygen reaction, whereby increasing the amount of power captured by the system.

21. A method of providing water and electricity comprising:
providing a source of electricity, and
providing a means of filtering ocean water, and
electrolyzing the filtered water with said electricity, and
transferring the resulting hydrogen, from the electrolysis, to a hydrogen-fired electric generator, and
injecting said hydrogen and oxygen into the combustion chamber of said hydrogen-fired electric generator, to produce thrust, and
rotating attached rotor, from said thrust, in close proximity to at least one stator, and
capturing the resulting water vapor, and
distilling said water vapor into usable water,
whereby a community's electricity and water supply is provided by a single hydrogen pipeline.

22. The method of providing water and electricity as claimed in claim 21 further comprising at least one turbine and and at least one electric generator, whereby the kinetic energy found in the oceans currents and tides is captured and utilized for the distillation and electrolysis of ocean water.

23. The method of providing water and electricity as claimed in claim 21 wherein said means of filtering ocean water is distillation.
